(19) United States
(12) Patent Application Publication
(10) Pub. No.: US 2026/0217546 A1
(43) Pub. Date: Jul. 30, 2026

(54) ELECTRODE ACTIVE MATERIAL COMPOSITE PARTICLE, METHOD FOR PRODUCING THE SAME, ELECTRODE MIXTURE, AND BATTERY

(71) Applicant: TOYOTA JIDOSHA KABUSHIKI KAISHA, Toyota-shi (JP)

(72) Inventor: Ryoshi OHTA, Susono-shi (JP)

(73) Assignee: TOYOTA JIDOSHA KABUSHIKI KAISHA, Toyota-shi (JP)

(21) Appl. No.: 19/413,590

(22) Filed: Dec. 9, 2025

(30) Foreign Application Priority Data
Jan. 29, 2025 (JP) 2025-013172

(51) Int. Cl. C01B 33/03; C01B 32/05

(52) U.S. Cl. CPC C01B 33/03; C01B 32/05; C01P 2002/08; C01P 2004/03; C01P 2004/62; C01P 2006/17; C01P 2006/40

(57) ABSTRACT

An electrode active material composite particle of the present disclosure includes a porous carbon material and spherical silicon particles retained within the porous carbon material. The electrode active material composite particle of the present disclosure has pores. A method for producing an electrode active material composite particle according to the present disclosure includes generating spherical silicon particles by decomposing a halogenated silane on the porous carbon material. An electrode mixture of the present disclosure includes the electrode active material composite particle of the present disclosure. A battery of the present disclosure includes an electrode active material layer, and the electrode active material layer contains the electrode mixture of the present disclosure.

### CROSS-REFERENCE TO RELATED APPLICATION

This application claims priority to Japanese Patent Application No. 2025-013172 filed on Jan. 29, 2025. The disclosure of the above-identified application, including the specification, drawings, and claims, is incorporated by reference herein in its entirety.

### BACKGROUND

### 1. Technical Field

The present disclosure relates to electrode active material composite particles, methods for producing the same, electrode mixtures, and batteries.

### 2. Description of Related Art

Japan Unexamined Patent Application Publication No. 2024-073597 (JP 2024-073597 A) discloses a composite including a porous carbon scaffold and silicon, and an electrode including such a composite. JP 2024-073597 A further discloses a method for embedding silicon within a porous carbon scaffold by chemical vapor deposition (CVD) using silane gas.

### SUMMARY

Silicon electrode active materials can expand and contract during battery charge and discharge. Accordingly, batteries that include a silicon electrode active material may undergo volume change associated with such expansion and contraction. Even for electrode active material composites containing a porous carbon material and silicon, there remains room for improvement in suppressing such battery volume changes.

An object of the present disclosure is to provide an electrode active material composite particle that can suppress battery volume changes, a method for producing the same, an electrode mixture including such an electrode active material composite particle, and a battery including such an electrode mixture.

The inventors have found that the above issue can be addressed by the following means.

### First Aspect

An electrode active material composite particle including: a porous carbon material; and spherical silicon particles retained within the porous carbon material, wherein the electrode active material composite particle has pores.

### Second Aspect

The electrode active material composite particle according to the first aspect, wherein the spherical silicon particles have an average particle size of 0.1 μm or more and 1.0 μm or less.

### Third Aspect

An electrode mixture including the electrode active material composite particle according to the first or second aspect.

### Fourth Aspect

A battery including an electrode active material layer, wherein the electrode active material layer contains the electrode mixture according to the third aspect.

### Fifth Aspect

A method for producing the electrode active material composite particle according to the first or second aspect, the method including generating the spherical silicon particles by decomposing a halogenated silane on the porous carbon material.

The present disclosure provides an electrode active material composite particle that can suppress battery volume changes, a method for producing the same, an electrode mixture including such an electrode active material composite particle, and a battery including such an electrode mixture.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional scanning electron microscope (SEM) image of electrode active material composite particles of the Example;

FIG. 2 is a graph showing the cumulative pore size distributions of the electrode active material composite particles of the Example and a porous carbon material;

FIG. 3 is a graph showing the differential pore size distributions of the electrode active material composite particles of the Example and the porous carbon material; and

FIG. 4 is a cross-sectional SEM image of electrode active material composite particles of the Comparative Example.

### DETAILED DESCRIPTION OF EMBODIMENTS

An embodiment of the present disclosure will be described in detail below. The present disclosure is not limited to the embodiment described below, and various modifications may be made within the scope of the present disclosure.

### Electrode Active Material Composite Particle

The electrode active material composite particle of the present disclosure includes a porous carbon material and spherical silicon particles retained within the porous carbon material. The electrode active material composite particle of the present disclosure has pores.

The inventors found that the electrode active material composite particle of the present disclosure can suppress battery volume changes associated with expansion and contraction of silicon particles during battery charge and discharge.

While not wishing to be bound by any theory, it is believed that the reason is as follows. In electrode active material composite particles having pores, the pores are believed to mitigate the effects of expansion and contraction of silicon particles during battery charge and discharge. Spherical silicon particles are considered to expand and contract isotropically. Accordingly, pores more effectively mitigate the effects of expansion and contraction of spherical silicon particles than those of non-spherical silicon particles, thereby suppressing battery volume changes.

The “electrode active material” may be a “cathode active material” or an “anode active material,” and may particularly be an “anode active material.”

The constituent elements of the electrode active material composite particle of the present disclosure will now be described.

### Porous Carbon Material

The electrode active material composite particle of the present disclosure includes a porous carbon material. The porous carbon material retains silicon within its pores.

The porous carbon material is not particularly limited. The porous carbon material may be, for example, activated carbon. The porous carbon material may be a material having interconnected pores. An example of such a material is CNovel (registered trademark) MH-00, which is commercially available.

The pore size and pore volume of the porous carbon material are not particularly limited. The porous carbon material may have pores of 10 nm or less in a volume of 0.30 cc/g or more, 0.40 cc/g or more, 0.50 cc/g or more, 0.55 cc/g or more, or 0.60 cc/g or more, and 1.00 cc/g or less, 0.90 cc/g or less, 0.80 cc/g or less, 0.75 cc/g or less, or 0.70 cc/g or less, as measured by a gas adsorption method.

In the differential pore size distribution of the porous carbon material as determined by a gas adsorption method, the maximum peak position may be at 1 nm or more, 2 nm or more, 3 nm or more, or 4 nm or more, and at 10 nm or less, 7 nm or less, 5 nm or less, or 4 nm or less.

The gas adsorption method is not particularly limited, and may, for example, involve measuring an N₂ adsorption isotherm and then obtaining a cumulative pore size distribution and a differential pore size distribution by the Barrett-Joyner-Halenda (BJH) method. In this case, BELSORP MAX X, a specific surface area and pore size distribution analyzer manufactured by Microtrac, can be used. The pore size and pore volume can be determined from the cumulative pore size distribution and differential pore size distribution thus obtained. The pore volume of the electrode active material composite particles described later can also be determined by the same method.

### Spherical Silicon Particles

The electrode active material composite particle of the present disclosure includes spherical silicon particles retained within the porous carbon material. This allows the pores to more effectively mitigate the effects of expansion and contraction of silicon particles, thereby suppressing battery volume changes.

The silicon is not particularly limited, and may, for example, be silicon produced from a halogenated silane as a raw material by the method described below.

In the present disclosure, “spherical” refers to a shape having an aspect ratio of 3 or less. Accordingly, the aspect ratio of the silicon particles may be 3.0 or less, 2.5 or less, 2.0 or less, 1.5 or less, 1.3 or less, 1.2 or less, or 1.1 or less, or may be 1.0.

For example, the aspect ratio may be determined from a cross-sectional SEM image of the electrode active material composite particles obtained by a scanning electron microscope (SEM). Specifically, for multiple particles in the image, the longest dimension of each particle between opposing ends is divided by its shortest dimension, and the aspect ratio is taken as the average of these values.

For example, a cross-sectional SEM image of the electrode active material composite particles can be obtained by the following method. First, the electrode active material composite particles are mixed with zinc powder, and the mixture is formed into a pellet using a press machine. A sample is then prepared by processing the pellet with a cross-section polisher, and a cross-sectional SEM image of the sample is obtained.

The average particle size of the spherical silicon particles may be 0.1 μm or more and 1.0 μm or less. The average particle size may be 0.1 μm or more, 0.2 μm or more, or 0.3 μm or more, and may be 1.0 μm or less, 0.8 μm or less, 0.6 μm or less, 0.5 μm or less, 0.4 μm or less, 0.3 μm or less, or 0.2 μm or less. This effectively suppresses battery volume changes.

The average particle diameter can be determined by observation with an electron microscope such as SEM. For example, the average particle diameter may be defined as the average of the maximum Feret diameters of multiple particles. It is preferable to use a large number of samples. The number of samples may be, for example, 20 or more, 50 or more, or 100 or more. The average particle size can be adjusted as appropriate by changing production conditions of silicon particles.

More specifically, the average particle size may be measured as follows. First, the electrode active material composite particles are mixed with zinc powder, and the mixture is formed into a pellet using a press machine. A sample is then prepared by processing the pellet with a cross-section polisher. The sample thus prepared is observed with an SEM. The diameter of each silicon particle can be measured using the scale bar at each magnification. The diameters of multiple silicon particles are measured, and the average of the measured diameters is calculated as an average particle size.

In the electrode active material composite particle of the present disclosure, the mass ratio of the spherical silicon particles to the porous carbon material may be 0.1 or more and 10.0 or less. This mass ratio may be 0.1 or more, 0.3 or more, 0.5 or more, 0.7 or more, 0.9 or more, or 1.0 or more, and may be 10.0 or less, 7.0 or less, 5.0 or less, 3.0 or less, 2.0 or less, or 1.0 or less. In other words, the mass ratio of the silicon particles to the porous carbon material may be 1:1.

### Pores

The electrode active material composite particle of the present disclosure has pores.

The pore volume is not particularly limited. For example, when three alumina boats are employed in the method for producing an electrode active material composite particle described below, the electrode active material composite particles obtained from the alumina boats located upstream, midstream, and downstream relative to the flow of Ar containing halogenated silane vapor may have the same pore volume or different pore volumes.

For the electrode active material composite particles obtained from the upstream alumina boat, the pore volume may be 500 cc/g or more, 600 cc/g or more, 700 cc/g or more, or 750 cc/g or more, and may be 900 cc/g or less, 850 cc/g or less, or 800 cc/g or less.

For the electrode active material composite particles obtained from the upstream and downstream alumina boats, the pore volume may be 300 cc/g or more, 400 cc/g or more, or 500 cc/g or more, and may be 700 cc/g or less, 600 cc/g or less, or 5500 cc/g or less.

In the differential pore size distribution obtained by a gas adsorption method, the maximum peak position of the electrode active material composite particles may be at 1 nm or more, 2 nm or more, 3 nm or more, or 4 nm or more, and may be at 10 nm or less, 7 nm or less, 5 nm or less, or 4 nm or less.

### Method for Producing Electrode Active Material Composite Particle

The method for producing an electrode active material composite particle according to the present disclosure includes generating spherical silicon particles by decomposing a halogenated silane on a porous carbon material.

The method of decomposing a halogenated silane on a porous carbon material is not particularly limited, and may be, for example, chemical vapor deposition (CVD). One specific example is as follows. First, an alumina boat containing a porous carbon material is placed in a tube furnace. The tube furnace is purged with argon (Ar) and heated. At this time, the Ar flow rate may be adjusted as appropriate, and may particularly be reduced. The Ar line is then switched from the tube furnace to a vessel containing a halogenated silane, and Ar is bubbled through the halogenated silane. The resulting Ar containing halogenated silane vapor is introduced into the tube furnace. At the same time, introduction of hydrogen into the tube furnace is started. By maintaining this state, the halogenated silane can be decomposed on the porous carbon material. As a result, spherical silicon particles are generated.

The halogenated silane is not particularly limited, and examples include tetrachlorosilane, trichlorosilane, dichlorosilane, and monochlorosilane. In particular, tetrachlorosilane (TCS) may be used. Accordingly, electrode active material composite particles including spherical silicon particles can be effectively produced.

The heating temperature is not particularly limited, and may be, for example, 300° C. or more, 500° C. or more, 600° C. or more, or 700° C. or more, and may be 1000° C. or less, 900° C. or less, 800° C. or less, or 700° C. or less.

The time during which the Ar gas containing halogenated silane vapor and hydrogen are introduced into the tube furnace is not particularly limited, and may be, for example, three hours or more, five hours or more, six hours or more, or seven hours or more, and may be 30 hours or less, 20 hours or less, 15 hours or less, 10 hours or less, eight hours or less, or seven hours or less.

### Electrode Mixture

The electrode mixture of the present disclosure includes the electrode active material composite particle of the present disclosure. The electrode mixture may optionally further contain a solid electrolyte, a conductive additive, a binder, and the like.

In the present disclosure, the “electrode mixture” refers to a composition that, by itself or with additional components, can constitute an electrode active material layer. The “electrode mixture slurry” refers to a slurry that contains the “electrode mixture” and a dispersion medium, and that can be applied and dried to form an electrode active material layer.

In the present disclosure, the “electrode mixture” may be either a “cathode mixture” or an “anode mixture,” and may particularly be an “anode mixture.”

The constituent elements of the electrode mixture of the present disclosure will now be described.

### Electrode Active Material Composite Particle

Reference can be made to the above description regarding the electrode active material composite particle.

The content of the electrode active material composite particles in the electrode mixture is not particularly limited, and may be set as appropriate in view of a desired battery capacity etc.

### Solid Electrolyte

Examples of the solid electrolyte include inorganic solid electrolytes such as sulfide solid electrolytes, oxide solid electrolytes, nitride solid electrolytes, or halide solid electrolytes, and organic polymer electrolytes such as polymer electrolytes. The solid electrolyte may particularly be a sulfide solid electrolyte.

For example, when the battery is a lithium-ion secondary battery, the solid electrolyte may be capable of conducting lithium ions.

Examples of sulfide solid electrolytes capable of conducting lithium ions include those containing Li, element X (X is at least one selected from P, As, Sb, Si, Ge, Sn, B, Al, Ga, and In), and S. The sulfide solid electrolyte may further contain either or both of O and a halogen element. Examples of halogen elements include F, Cl, Br, and I.

Examples of sulfide solid electrolytes include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numerals, and Z is any one element selected from Ge, Zn, and Ga), Li₂S—GeS₂, Li₂S—SiS₂—Li₃PO₄, and Li₂S—SiS₂-LiₓMO_{y} (where x and y are positive numerals, and M is any one element selected from P, Si, Ge, B, Al, Ga, and In).

Examples of oxide solid electrolytes capable of conducting lithium ions include solid electrolytes containing Li, element Y (Y is at least one element selected from Nb, B, Al, Si, P, Ti, Zr, Mo, W, and S), and O. Specific examples include garnet solid electrolytes such as Li₇La₃Zr₂O₁₂, Li₇₋ₓLa₃(Zr₂₋ₓNbₓ)O₁₂ (0≤x≤2), and Li₅La₃Nb₂O₁₂; perovskite solid electrolytes such as (Li,La)TiO₃, (Li,La)NbO₃, and (Li,Sr)(Ta, Zr)O₃; NASICON solid electrolytes Li(Al,Ti)(PO₄)₃ and Li(Al, Ga)(PO₄)₃; Li—P—O-based solid electrolytes such as Li₃PO₄ and LIPON (a compound in which part of O in Li₃PO₄ is substituted with N); and Li—B—O-based solid electrolytes such as Li₃BO₃ and a compound in which part of O in Li₃BO₃ is substituted with C.

The content of the solid electrolyte in the electrode mixture is not particularly limited, and may be set as appropriate in view of desired ion conduction properties etc.

### Conductive Additive

The conductive additive may be, for example, a carbon material, metal particles, or a combination thereof. Examples of carbon materials include non-fibrous carbons such as acetylene black (AB) and Ketjenblack (KB), fibrous carbons such as vapor-grown carbon fibers (VGCFs), carbon nanotubes (CNTs), and carbon nanofibers (CNFs), and combinations thereof. Examples of metal particles include nickel, copper, iron, stainless steel, and combinations thereof.

The content of the conductive additive in the electrode mixture is not particularly limited, and may be set as appropriate in view of desired conductive properties etc.

### Binder

The binder may be, for example, a rubber-based binder such as butadiene rubber, hydrogenated butadiene rubber, styrene butadiene rubber (SBR), hydrogenated styrene butadiene rubber, nitrile butadiene rubber, hydrogenated nitrile butadiene rubber, acrylate butadiene rubber (ABR), or ethylene propylene rubber; a fluoride-based binder such as polyvinylidene fluoride (PVDF), polyvinylidene fluoride-polyhexafluoropropylene copolymer (PVDF-HFP), polytetrafluoroethylene, or fluororubber; a polyolefin-based thermoplastic resin such as polyethylene, polypropylene, or polystyrene; an imide-based resin such as polyimide or polyamide-imide; an amide-based resin such as polyamide; an acrylic resin such as polymethyl acrylate or polyethyl acrylate; a methacrylic resin such as polymethyl methacrylate or polyethyl methacrylate; or a combination thereof.

The content of the binder in the electrode mixture is not particularly limited, and may be set as appropriate in view of desired binding properties etc.

### Other Components

The electrode mixture may or may not further contain components other than those described above.

### Battery

The battery of the present disclosure includes an electrode active material layer, and the electrode active material layer contains the electrode mixture of the present disclosure. The battery of the present disclosure may include, in this order, an anode current collector layer, an anode active material layer, an electrolyte layer, a cathode active material layer, and a cathode current collector layer. In this case, the electrode active material layer containing the electrode mixture of the present disclosure may be either the anode active material layer or the cathode active material layer, and may particularly be the anode active material layer.

The battery of the present disclosure may be a liquid battery or a solid-state battery, and may particularly be a solid-state battery. In the present disclosure, the “solid-state battery” refers to a battery that includes at least a solid electrolyte as the electrolyte. Accordingly, the solid-state battery may employ a combination of a solid electrolyte and a liquid electrolyte as the electrolyte. The battery may be an all-solid-state battery that includes a solid electrolyte alone as the electrolyte.

The battery of the present disclosure may be either a primary battery or a secondary battery, and may particularly be a lithium-ion secondary battery.

The battery pf the present disclosure may be restrained by restraining members such as end plates from both sides in the stacking direction of the layers. Examples of restraining methods include, but are not limited to, utilizing clamping torque of bolts.

The components of the battery of the present disclosure will be described below. The following description illustrates a case in which the electrode active material layer containing the electrode mixture of the present disclosure is an anode active material layer.

### Anode Current Collector Layer

The anode current collector layer may be in the form of a foil, plate, mesh, punched metal, or foam. The anode current collector layer may be a metal foil or metal mesh, or a carbon sheet, and may particularly be a metal foil. The anode current collector layer may be formed of a plurality of foils or sheets.

The metal forming the anode current collector layer is not particularly limited, and may be, for example, copper, nickel, chromium, gold, platinum, silver, aluminum, iron, titanium, zinc, cobalt, or stainless steel. In particular, the anode current collector layer may include at least one selected from copper, nickel, and stainless steel.

A coating layer may be formed on the surface of the anode current collector layer for purposes such as resistance adjustment. The anode current collector layer may be a metal foil or substrate plated or vapor-deposited with any of the above metals. When the anode current collector layer is formed of a plurality of metal foils, it may further include a layer between these metal foils.

The thickness of the anode current collector layer is not particularly limited, and may be, for example, 0.1 μm or more, or 1 μm or more, and may be 1 mm or less, or 100 μm or less.

### Anode Active Material Layer

The anode active material layer contains the electrode mixture of the present disclosure. Reference can be made to the above description regarding the electrode mixture of the present disclosure. The anode active material layer may be formed by shaping the electrode mixture of the present disclosure itself into a layer.

The thickness of the anode active material layer is not particularly limited, and may be, for example, 0.1 μm or more and 1000 μm or less.

### Solid Electrolyte Layer

The solid electrolyte layer contains at least solid electrolyte particles, and may optionally further contain a binder and the like.

Reference can be made to the above description regarding the solid electrolyte particles and the binder.

The thickness of the solid electrolyte layer is not particularly limited, and may be, for example, 0.1 μm or more and 1000 μm or less.

### Cathode Active Material Layer

The cathode active material layer contains at least a cathode active material, and may optionally further contain a solid electrolyte, a conductive additive, a binder, and the like.

The cathode active material is not particularly limited, and may be, for example, an oxide active material. The oxide active material used in lithium-ion batteries may be, for example, LiCoO₂, LiMnO₂, Li₂NiMn₃O₈, LiVO₂, LiCrO₂, LiFePO₄, LiCoPO₄, LiNiO₂, or LiNi_{1/3}Co_{1/3}Mn_{1/3}O₂. A coating layer containing a Li-ion conductive oxide such as LiNbO₃ may be formed on the surface of these active materials.

The content of the cathode active material in the cathode active material layer is not particularly limited.

Reference can be made to the above description regarding the solid electrolyte, the conductive additive, and the binder.

The thickness of the cathode active material layer is not particularly limited, and may be, for example, 0.1 μm or more and 1000 μm or less.

### Cathode Current Collector Layer

The cathode current collector layer may be in the form of a foil, plate, mesh, punched metal, or foam. The cathode current collector layer may be a metal foil or metal mesh, and may particularly be a metal foil. The cathode current collector layer may be formed of a plurality of foils.

The metal forming the cathode current collector layer is not particularly limited, and may be, for example, copper, nickel, chromium, gold, platinum, silver, aluminum, iron, titanium, zinc, cobalt, or stainless steel. In particular, the cathode current collector layer may include aluminum.

A coating layer may be formed on the surface of the cathode current collector layer for purposes such as resistance adjustment. The cathode current collector layer may be a metal foil or substrate plated or vapor-deposited with any of the above metals. When the cathode current collector layer is formed of a plurality of metal foils, it may further include a layer between these metal foils.

The thickness of the cathode current collector layer is not particularly limited, and may be, for example, 0.1 μm or more, or 1 μm or more, and may be 1 mm or less, or 100 μm or less.

### Other Configurations

The above components of the battery may be housed in an outer casing. The outer casing may be any conventionally known battery casing. A plurality of batteries may be electrically connected as desired and/or stacked as desired to form a battery pack. In this case, the battery pack may be housed inside a known battery case. The battery may also include other obvious components such as necessary terminals. The battery may be, for example, of a coin type, a laminate (pouch) type, a cylindrical type, or a prismatic type.

The method for manufacturing the battery of the present disclosure is not particularly limited and may include, for example, forming an electrode active material layer containing the electrode mixture of the present disclosure.

For example, an electrode active material layer containing an electrode mixture may be formed by mixing constituent materials such as electrode active material composite particles to obtain the electrode mixture, and then forming the obtained electrode mixture into a layer by dry or wet forming.

The method for manufacturing the battery of the present disclosure may further include laminating, in this order, an anode current collector layer, an anode active material layer, a solid electrolyte layer, a cathode active material layer, and a cathode current collector layer to form an electrode laminate.

Other members such as terminals may be attached to the electrode laminate, as necessary. The battery is obtained by housing the electrode laminate in a battery case and sealing it.

### Example

### Synthesis of Electrode Active Material Composite Particles

Three alumina boats containing a porous carbon material were placed in a tube furnace. The amount of porous carbon material was 0.2 g per boat. At room temperature, the tube furnace was purged with argon (Ar). At this time, the Ar flow rate was 1 L/min. The Ar flow rate was then reduced to 100 mL/min, and the temperature inside the tube furnace was raised to 700° C. Thereafter, the Ar line was switched from the tube furnace to a vessel containing tetrachlorosilane (TCS), Ar was bubbled through the TCS, and the resulting Ar containing TCS vapor was introduced into the tube furnace. At the same time, introduction of hydrogen into the tube furnace was started. The hydrogen flow rate was 10 mL/min. After one hour, the introduction of the Ar containing TCS and hydrogen was stopped. As a result, TCS was decomposed on the porous carbon material, thereby generating spherical silicon particles. Thus, electrode active material composite particles containing the porous carbon material and spherical silicon particles retained within the porous carbon material were obtained. Thereafter, only Ar was introduced into the tube furnace, the tube furnace was allowed to cool to room temperature, and the obtained electrode active material composite particles were collected.

### Cross-Sectional Observation of Spherical Silicon Particles

The electrode active material composite particles were mixed with zinc powder, and the mixture is formed into a pellet using a press machine. A sample was then prepared by processing the pellet with a cross-section polisher, and a cross-sectional SEM image of the sample was obtained.

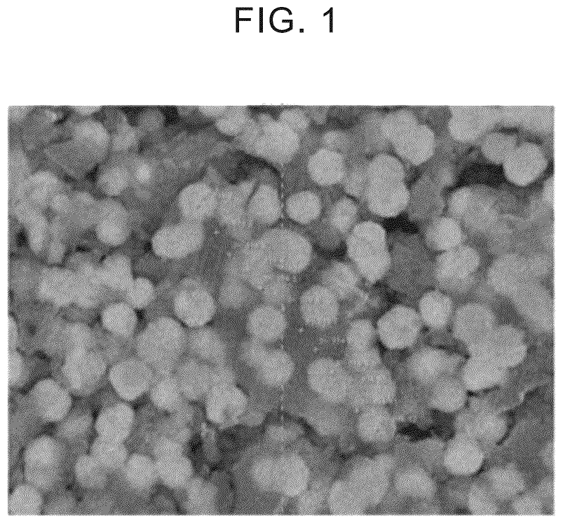

The obtained cross-sectional SEM image is shown in FIG. 1. As shown in FIG. 1, the silicon particles in the electrode active material composite particles of the Example were spherical. This was the same for the electrode active material composite particles obtained from each of the three alumina boats.

Such spherical silicon particles expand and contract isotropically. This suggests that the pores more effectively mitigate the effects of expansion and contraction of spherical silicon particles than those of non-spherical silicon particles, thereby suppressing battery volume changes.

### Obtaining Pore Size Distribution

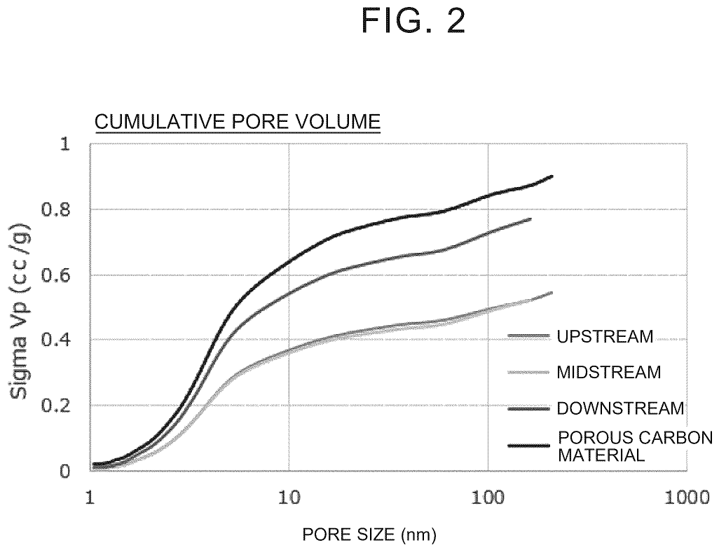

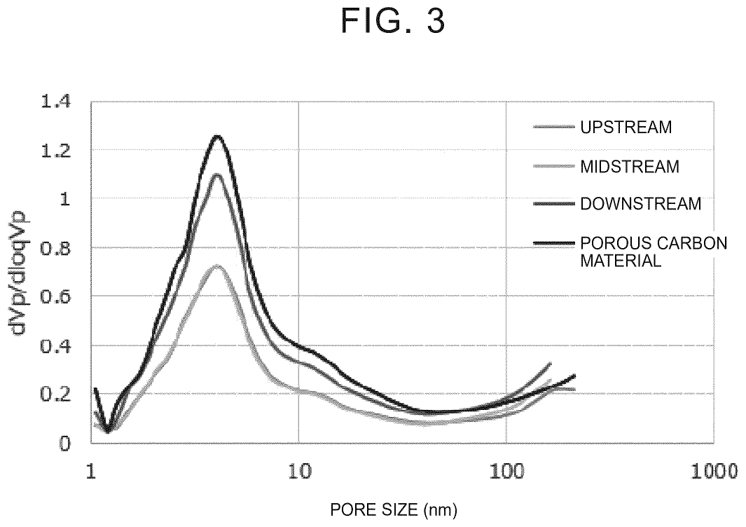

For the electrode active material composite particles of the Example and, for reference, the porous carbon material, N₂ adsorption isotherms were measured, and cumulative pore size distribution and differential pore size distribution were obtained by the Barrett-Joyner-Halenda (BJH) method. In the measurement by the BJH method, BELSORP MAX X, a specific surface area and pore size distribution analyzer manufactured by Microtrac, was be used. The obtained cumulative pore size distribution and differential pore size distribution are shown in FIGS. 2 and 3, respectively. Pore volumes were determined from the obtained pore size distributions. The results are shown in Table 1. In FIGS. 2 and 3 and Table 1, “upstream,” “midstream,” and “downstream” refer to the positions of the three alumina boats relative to the flow of Ar containing TCS vapor.

TABLE 1

| | Pore Volume |
|---|---|
| | (oc/g) |
| Upstream | 0.543 |
| Midstream | 0.524 |
| Downstream | 0.770 |
| Porous Carbon Material | 0.902 |

### Comparative Example

Electrode active material composite particles of the Comparative Example were obtained in the same manner as in the Example, except that monosilane gas was introduced into the tube furnace instead of Ar containing TCS vapor. A cross-sectional SEM image was then obtained.

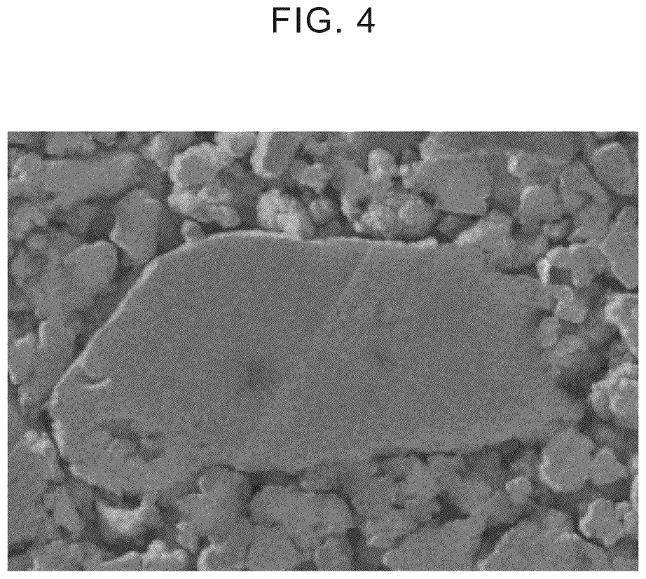

The obtained cross-sectional SEM image is shown in FIG. 4. As shown in FIG. 4, in the electrode active material composite particles of the Comparative Example, the silicon particles were so fine that their shapes could not be observed and their average particle size could not be measured.

What is claimed is:

1. An electrode active material composite particle, comprising:
a porous carbon material; and
spherical silicon particles retained within the porous carbon material, wherein the electrode active material composite particle has pores.

2. The electrode active material composite particle according to claim 1, wherein the spherical silicon particles have an average particle size of 0.1 μm or more and 1.0 μm or less.

3. An electrode mixture comprising the electrode active material composite particle according to claim 1.

4. A battery comprising an electrode active material layer, wherein the electrode active material layer contains the electrode mixture according to claim 3.

5. A method for producing the electrode active material composite particle according to claim 1, the method comprising generating the spherical silicon particles by decomposing a halogenated silane on the porous carbon material.
